(19) United States
(12) Patent Application Publication
(10) Pub. No.: US 2014/0278522 A1
(43) Pub. Date: Sep. 18, 2014

(54) RIGHT PATIENT SITUATIONAL AWARENESS SYSTEM

(71) Applicant: CERNER INNOVATION, INC., Lenexa, KS (US)

(72) Inventors: KAREN RAMSEY, Lenexa, KS (US); KRISTINE MARIE NESSA, Overland Park, KS (US)

(73) Assignee: CERNER INNOVATION, INC., Lenexa, KS (US)

(21) Appl. No.: 13/796,227

(22) Filed: Mar. 12, 2013

(51) Int. Cl. G06F 19/00

(52) U.S. Cl. CPC G06F 19/322
USPC 705/3

(57) ABSTRACT

Methods, computer systems, and computer storage media are provided for notifying a clinician that he or she may be accessing incorrect health information. Based on inputs received from a plurality of healthcare systems, a determination is made that health information being accessed is incorrect because it fails to include patient-identifying information for a particular patient, or it fails to include a patient encounter code associated with a particular ongoing patient encounter. Upon determining that the health information is incorrect, a notification is communicated to the clinician accessing the incorrect health information.

### BACKGROUND

Electronic medical records (EMRs) contain copious amounts of data relating to potentially thousands of patients and patient encounters. It is not uncommon, therefore, for clinicians to occasionally access incorrect patient information within an electronic medical record (EMR). Likewise, it is not uncommon for clinicians to document incorrect health information in an EMR. Oftentimes, clinicians fail to notice such inaccuracies. Failing to notice that incorrect health information has been accessed or documented, however, may lead to poor record-keeping, improper billing, and possibly, improper clinical care.

Clinicians have developed some practices to decrease the likelihood that incorrect patient information will be accessed or documented during a patient encounter. For example, during surgery, clinicians may request a “time-out” or a “hard stop” before the surgery begins. A hard stop is a clinician-initiated pause, during which time clinicians halt what they are doing to confirm that they are accessing and/or documenting correct health information. If during the hard stop a clinician discovers that incorrect health information has been entered in the wrong patient record, for example, the clinician can return to the record containing the incorrect information, remove or inactivate the incorrect information already entered, and reenter or transfer the correct information to the correct patient record.

A hard stop is neither efficient nor extremely effective, however, because clinicians may still access or document incorrect health information after surgery resumes. Further, a hard stop is unique to surgery; many other patient encounters do not involve cross-checking procedures to ensure that clinicians are accessing or documenting correct health information. Thus, improvements are needed to ensure that accurate health information is accessed and documented in patient EMRs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer storage media for determining that a clinician is accessing or documenting incorrect health information. Health information may be determined to be incorrect because it does not contain patient-identifying information for a patient that is currently or has recently interacted with the clinician that is accessing the health information. Health information may similarly be determined to be incorrect because it does not relate to a patient encounter in which the clinician and the patient are currently interacting or have recently interacted. Health information may also be determined to be incorrect because it does not relate to an ongoing patient encounter. Upon determining that the clinician is accessing incorrect health information, a notification is sent to the clinician.

### BRIEF DESCRIPTION OF THE DRAWINGS

Embodiments are described in detail below with reference to the attached drawing figures, wherein:

FIG. 1 is a system diagram of an exemplary computing environment suitable to implement embodiments of the present invention;

FIG. 2 is a system diagram of an exemplary system for identifying health information being accessed during a particular patient encounter suitable to implement embodiments of the present invention;

FIG. 3 is a flow diagram of an exemplary method for determining that a clinician is accessing incorrect health information for a patient according to an embodiment of the present invention;

FIG. 4 is a flow diagram of an exemplary method for determining that a clinician is accessing incorrect health information for a patient encounter according to an embodiment of the present invention; and

FIG. 5 is a flow diagram of an exemplary method for determining that a clinician is accessing incorrect health information for a patient encounter according to an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, computer systems, and computing storage media for determining that a clinician is accessing or documenting incorrect health information. Health information may be determined to be incorrect because it does not contain patient-identifying information for a patient that is currently or has recently interacted with the clinician that is accessing the health information. Health information may similarly be determined to be incorrect because it does not relate to a patient encounter in which the clinician and the patient are currently interacting or have recently interacted. Health information may also be determined to be incorrect because it does not relate to an ongoing patient encounter. Upon determining that the clinician is accessing incorrect health information, a notification is sent to the clinician.

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise non-transitory computer storage media and communication media. Non-transitory computer storage media includes both volatile and nonvolatile, removable and non-removable media implemented in any method or technology for storage of information such as computer-readable instructions, data structures, program modules or other data. Non-transitory computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

Turning now to FIG. 2, an exemplary computing system environment, referenced generally by the numeral 200, is depicted for identifying incorrect health information being accessed or documented by one or more clinicians. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a data store 202, a situational awareness system 206, an end-user computing device 208, and healthcare systems 210. The data store 202, the situational awareness system 206, the end-user computing device 208, and the healthcare systems 210 all communicate with one another via a network 204. The network 204 may include, without limitation, one or more local area networks (LANs) and/or wide area networks (WANs). Such networking environments are commonplace in offices, enterprise-wide computer networks, intranets and the Internet. Accordingly, the network 204 is not further described herein.

The data store 202, the situational awareness system 206, the end-user computing device 208, and the healthcare systems 210 are merely exemplary. While each of these components/services/modules is illustrated as a single unit, it will be appreciated that each of these components/services/modules is scalable. For example, the situational awareness system 206 may in actuality include a plurality of computing devices in communication with one another. Components of the situational awareness system 206, the end-user computing device 208, and the healthcare systems 210 may include a processing unit, internal system memory, and a suitable system bus for coupling various system components, including one or more data stores for storing information (e.g., files and metadata associated therewith). Each of these components/services/modules typically includes, or has access to, a variety of computer-readable media.

In some embodiments, one or more of the illustrated components/modules may be implemented as stand-alone applications. In other embodiments, one or more of the illustrated components/modules may be integrated directly into the situational awareness system 206. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the situational awareness system 206 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 202 is configured to store information for use by, for example, the situational awareness system 206, the end-user computing device 208, or the healthcare systems 210. The information stored in association with the data store 202 is configured to be searchable for one or more items of information stored in association therewith. The information stored in association with the data store 202 may comprise general information used by the situational awareness system 206.

The data store 202 may store EMRs of patients associated with one or more healthcare facilities. EMRs may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment and/or patient encounter associated with a particular patient and can include information relating to, for example, patient identification information, images, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information. The EMRs may also contain billing information, such as billing codes or patient encounter codes for a particular patient or a particular patient encounter, dates of admission and discharge from healthcare facilities, active and inactive patient encounter rows in a patient chart, and the like.

The data store 202 is also configured to store patient-identifying information. Such information may include, for example, a patient's name, social security number, date of birth, gender, address, a unique patient code, and the like. Additional patient information may include a patient's medical history, surgical history, family history, history of present illness, indications of active and/or completed patient encounters, and other relevant clinical information related to the patient, such as the information stored in the patient's EMR. Patient-identifying information is utilized, as described below, to determine whether a clinician is accessing correct health information for a patient.

Similarly, the data store 202 is configured to store information about patient encounters. Patient encounters may be generally defined as any interaction between a patient and at least one clinician for the purpose of treating, diagnosing, opining on, researching, and/or examining a medical condition or trait of patient. Additionally, a patient encounter may be generally defined as a healthcare event that includes, at least, a patient, a clinician, and a service for which the patient is billed. It is worth noting, however, that a patient and a clinician do not need to physically interact or be present in the same general location for them to be involved in a patient encounter. For example, an interaction may describe a patient encounter when a clinician is located remotely, such as in a satellite clinic or a lab.

A patient encounter also may be generally defined as a visit to a healthcare facility. For example, a patient with chronic heart disease may have multiple patient encounters relating to each of his visits to his cardiologist for treatment or maintenance of his heart disease. In this way, a patient encounter may begin upon a patient's admittance to, arrival at, or check-in to a healthcare facility. A patient encounter may be complete, therefore, when the patient departs from or is discharged from the same healthcare facility. Thus, an ongoing patient encounter describes a patient encounter, such as as an ongoing visit to a healthcare facility, an ongoing medical treatment, and/or an ongoing interaction between a clinician and a patient. A patient encounter that has not yet started may generally be defined as a visit, a medical service/treatment, or an interaction between at least one clinician and one patient, that is scheduled to occur in the future (e.g., a doctor's appointment scheduled for three weeks from now).

The data store 202 is configured to store patient encounter codes that identify specific patient encounters. In one embodiment, a patient encounter code is a billing code that is associated with a service or treatment for which payment is due or will become due upon completion of a patient encounter. Such codes are commonly used by healthcare organizations and insurance companies for reimbursement purposes. It will be understood, however, that billing codes are merely exemplary, and many different identifiers or descriptors may be used as patient encounter codes. For example, a patient encounter code may also include a unique combination of alphanumeric characters that serves to identify a type of treatment, a part of the body, a condition, a group of treatments logically associated with each other (e.g., surgery and subsequent recovery), or the like. No two patient encounter codes are identical; rather, each patient encounter code is unique. As well, patient encounter codes may be assigned by a healthcare facility system or administrator based on healthcare facility-specific preferences.

The healthcare systems 210 are configured to execute specified functions related to, for example, patients, clinicians, and patient encounters. The situational awareness system 206 may utilize the information generated by the healthcare systems 210 to determine, for example, that a patient encounter is ongoing, to identify a patient and patient encounter for which a clinician should be accessing related health information, and to determine that a clinician is accessing or documenting correct health information during a patient encounter.

Exemplary systems within the healthcare systems 210 include real-time location, scheduling, billing, staff assignment, and pharmacy systems. While the healthcare systems 210 are depicted as distinct systems in FIG. 2, it will be understood that the healthcare systems 210 may be combined into one or more systems, separated into one or more other systems, or able to perform the same or similar functions as any other healthcare system described herein. Further, the healthcare systems 210 are merely exemplary and are not meant to be limiting. It will be understood that other healthcare systems capable of communicating via the network 204 are within the scope of the embodiments described herein.

The real-time location system (RTLS) is configured to utilize known technology to track identifiers. Identifiers may be tracked using infrared (IR) technology, radio-frequency identification (RFID) technology, or wireless local area networks. The RTLS 210 is configured to utilize, for example, RFID identifiers located on patients, clinicians and/or equipment to track, locate and identify the clinicians, patients and/or equipment, respectively. Exemplary identifiers may include badges, tags, and wristbands. For example, the RTLS 210 can detect a patient's RFID wristband, locate the patient, identify the patient, and communicate the location and identity information to the situational awareness system 206 via the network 204.

The scheduling system is configured to receive and store scheduling information. Such information may include a date, time, and expected duration and location of a patient encounter. The scheduling system may also receive and store identifying information for clinicians and/or patients scheduled to participate in patient encounters. For example, the scheduling system may store information that indicates that physician A is scheduled to perform surgery on patient X in operating room 100 at 8:00 AM on Feb. 12, 2013. As well, the scheduling system may store reminders for incomplete tasks, such as incomplete or absent notations or orders in a patient EMR. The scheduling system is also configured to schedule devices, equipment, inventory, or rooms, such as operating, imaging, examination, or conference rooms, for use within a healthcare facility.

The billing system is configured to store billing information for patient encounters and/or patients. Billing information may include an amount due, a collection date and/or associated late fees or interest on past due amounts. Billing information may be described according to distinct patient encounters (e.g., separate bills for each of a mammography exam and a chemotherapy treatment), or it may cumulatively describe multiple patient encounters (e.g., one bill for each service provided to a patient by a particular healthcare provider over the course of a year). Billing information may also include unique billing codes that are used to define and/or describe specific patient encounters. As described above, such billing codes may serve as patient encounter codes, providing an indication of the type and duration a patient encounter. Billing information may also indicate that a patient encounter has been completed. For example, if a bill has been paid for a medical service, the patient encounter is likely complete, as further described below.

The staff assignment system stores information about clinician and/or staff assignments within a healthcare facility. The assignments may include information, such as, for example, an identification of a patient encounter (e.g., Bob Smith's open heart surgery), the names of clinicians assigned to a patient encounter, a room where a patient encounter is scheduled to take place, or the like. The staff assignment system may be used by operating room directors, head charge nurses, other clinicians, and administrators to plan out a prospective day. Information stored in the staff assignment system can be used by the determining component 224 to determine that a patient encounter is ongoing, a patient encounter has not begun, or that a patient encounter is complete.

The pharmacy system stores pharmaceutical information related to prescription or over-the-counter medications, products and/or devices. Such pharmaceutical information may include dosage levels, usage instructions, side effect information, pick-up date and time, allergy information, where a drug was administered, delivery information, and the like.

The end-user computing device 208 and the display monitor 209 are configured to depict a view of a patient's healthcare information to a clinician caring for the patient. The user may be an employee at the clinical site and be involved in the patient's care (e.g., a nurse, therapist, social worker, etc.). As well, the user may be a clinician who has privileges at the clinical site and is also involved in the patient's care.

The user can access health information using the end-user computing device 208. The end-user computing device 208 is configured to communicate via the network 204 to display data from, for example, the data store 202, the situational awareness system 206, and/or the healthcare systems 210. Further, the user can manually input health information into the end-user computing device 208 for storage by one of the systems described herein.

As shown, the end-user computing device 208 includes a display monitor 209. The display monitor 209 is configured to present information to the user of the end-user computing device 208, such as information relevant to communications initiated and/or received by the end-user computing device 208, waveform tracings, patient information, vital signs information, and the like. The display monitor 209 may be located in a central location such as a nursing or clinician station. The display monitor 209 also may be located remotely or in a non-central location, such as an operating room. Nursing or clinician stations are generally designed to display information associated with the care of one or more patients who are located in the healthcare facility unit. The display monitor 209 may be configured to present information associated with patients located in the unit to caregivers at the nursing or clinician station or a non-central location, such as an operating room. Further, the display monitor 209 may comprise one or multiple display monitors. Embodiments are not intended to be limited to visual display but rather may also include audio presentation, combined audio/visual presentation, and the like.

The end-user computing device 208 might also include a tablet PC (personal computer). For example, a clinician participating in a surgery might use a tablet PC to access patient information during the surgery. The tablet PC might have capabilities such as, for example, portability, a flat touch screen display (i.e., the display monitor 209), a Web browser, an accelerometer, ambient light and proximity sensors, microphones, and cameras. In addition, a tablet PC may have the ability to render three-dimensional images. Thus, a clinician could, for example, access X-Ray images or CT scans on a tablet PC.

As shown in FIG. 2, the situational awareness system 206 comprises a receiving component 222, a determining component 224, an accessing component 226, and a notifying component 228. The situational awareness system 206 typically includes, or has access to, a variety of computer-readable material. In some embodiments, one or more of the components 222, 224, 226 and 228 may be implemented as stand-alone applications. In other embodiments, one or more of the components 222, 224, 226 and 228 may be integrated directly into the operating system of a computing device such as the remote computer 108 of FIG. 1. It will be understood that the components 222, 224, 226 and 228 illustrated in FIG. 2 are exemplary in nature and in number and should not be construed as limiting. Any number of components may be employed to achieve the desired functionality within the scope of embodiments hereof.

The receiving component 222 is configured to receive patient information that is associated with a patient. Patient information may be received from the healthcare systems 210, the data store 202 (e.g., a patient EMR), or the end-user computing device 208. Information associated with a patient may be patient-identifying. Exemplary patient-identifying information includes, for example, a patient name, address, birth date, social security number, gender, age, phone number, and the like.

Patient information may also include location information associated with a patient location. Such information may be gleaned from, for example, clinical documents, transfer orders, admit and discharge information, scheduling information, staff assignment information, or real-time location systems. Patient information associated with a patient location may indicate a room, a floor, a stairway, an elevator, a hallway, a common area, or any other area within a healthcare facility that describes the current location, or a likely location, of a patient. Patient information associated with a patient location may also indicate that a patient's location is transitory (i.e., the patient is moving). As well, patient information associated with a patient location may include a patient's location in relation to other objects or people, such as a patient's proximity to a clinician assigned to care for the patient. Additionally, patient information associated with a patient location may simply provide an indication (e.g., scheduling information), rather than pinpoint (e.g., real-time location information), the location of a patient. For example, location information may include a patient's transfer location as indicated in a recent transfer order, even though the patient has not yet been transferred to the transfer location.

Patient information may also describe a patient encounter. Health information describing a patient encounter may include an identity of a patient involved in a patient encounter. As well, patient information describing a patient encounter may describe a reason for (e.g., a persistent medical condition), a type of (e.g., a hip surgery), a duration of (e.g., 10 days), or a start and completion time for a patient encounter for the patient (e.g., an admit date/time and a corresponding discharge date/time). Information associated with a patient encounter, as described above, may also include inputs used to describe an interaction between the patient and a clinician, or it may be associated with a patient's visit to a healthcare facility. Patient information describing a patient encounter may similarly include information relating to the health history of a patient, such as, for example, one or more medical treatments for, or conditions, studies, diagnoses, or prognoses of, a patient.

Additional patient information may indicate the status of a patient encounter as ongoing, completed or not yet started. Such information may include, for example, scheduling information (e.g., information indicating that a patient's surgery recently began and will end three hours from now), staff assignment information (e.g., information that a clinician is scheduled to round on an admitted patient for the next ten days until the patient is discharged), billing information (e.g., information that a bill is opened but not closed because treatment for a patient is not complete), pharmacy information (e.g., information that indicates that a patient is currently receiving chemotherapy treatment), orders, clinical notes, and the like.

Patient information may also include patient encounter codes associated with patient encounters. Health information stored in the EMR may contain a patient encounter code that relates to the corresponding patient encounter. Patient encounter codes may also appear in billing documents, scheduling orders, staff assignment orders, clinical orders, clinical notes, and the like.

The receiving component 222 is also configured to receive clinician information that is associated with one or more clinicians. Clinician information may be received from, for example, the healthcare systems 210, the data store 202, or the end-user computing device 208. Information associated with clinicians may include identifying information (e.g., name, address, specialty, age, gender, and the like). Clinician information may also include names of patients to whom a clinician is assigned (e.g., names listed within a patient chart or a staff assignment order), as well as the role of the clinician (e.g., attending physician, head operating nurse, technician, or the like) in caring for those patients. Conversely, clinician information may indicate that a clinician is not assigned to provide medical care, treatment or services to a particular patient. Additional clinician information may include documentation, such as notes, orders, dictations, and other records kept and/or entered into a patient EMR by a clinician, detailing the responsibilities of the clinician. Clinician information can include an identity of one or more communication devices (e.g., pagers, computers, phones, and the like) associated with a clinician, as well as information about how to communicate with clinicians on such devices (e.g., pager numbers, email addresses, phone numbers, or the like).

Clinician information may also include location information associated with a clinician. Such information may be gleaned from, for example, clinical documents, transfer orders, admit and discharge information, scheduling information, staff assignment information, or real-time location systems. Much like location information for a patient, location information for a clinician may include a room, a floor, a stairway, an elevator, a hallway, a common area, or any other area within a healthcare facility that indicates the location, or a likely location, of a clinician. Clinician information associated with a clinician's location also may indicate that a clinician's movement is transitory. As well, clinician information associated with a clinician's location may be described with reference to a clinician's location to other objects or people, such as a clinician's proximity to a patient. Additionally, clinician information that simply suggests, rather than locates with specificity, a likely location of a clinician may be received by the receiving component 222.

The receiving component 222 is also configured to receive an indication that clinicians are accessing and/or documenting health information within a patient EMR. Such information may include an indication that a clinician is logged in to the end-user computing device 208 and has a patient EMR application open on the end-user computing device 208. Login information may include the name of the clinician, as well as the clinician's login credentials (e.g., a user name and password). Login information may include authentication information, such as an indication that a clinician's login credentials have been authenticated. As well, the receiving component 222 is configured to receive information about the end-user computing device 208 upon which the clinician is accessing health information in a patient EMR. Information about the end-user computing device 208 may include the location of the computing device, the type of computing device, and log in history for the computing device.

The receiving component 222 is also configured to receive an indication of the type and content of health information that a clinician is accessing and/or documenting once the clinician is logged in to the patient EMR. Health information is any information contained within or documented in a patient EMR. An indication of the type of health information that is being accessed or documented is based on the content included within open EMR applications on the computing device(s).

In one embodiment, the determining component 224 is configured to determine that a clinician is accessing and/or documenting correct health information for a patient. The determining component 224 makes such a determination based, at least in part, on first determining that a patient and at least one clinician are in the same location, are interacting with one another, or have recently interacted with one another. The determining component 224 is then configured to determine that patient EMRs being accessed by the at least one clinician contain patient-identifying information for the patient that is interacting with the clinician.

Thus, the determining component 224 may first utilize patient and clinician information to determine that a patient and at least one clinician are in the same location. A clinician may be at a location associated with the patient, if the clinician is in the same room as the patient. As well, clinicians may be at a location associated with the patient depending on the position of clinicians in relation to a patient. For example, if five clinicians are surrounding a patient (such as in a circle around the patient), the clinicians may be considered to be located at the same location as the patient. A clinician may be at a location associated with the patient, if the clinician is within a predefined distance (e.g., five feet) to the patient, as specified by a user of the situational awareness system 206. Thus, if patient information and clinician location information suggest that a patient and clinician are at a same location (e.g., operating room 1 at 4:00 PM on Feb. 15, 2013), the determining component 224 may determine that the clinician is at a location associated with the patient.

In another aspect, the determining component 224 utilizes patient and clinician information to determine that a patient and at least one clinician are interacting or have recently interacted with each other. An interaction between a clinician and a patient may generally be defined as an event wherein a patient and clinician are located in close proximity to one another or wherein the clinician's and/or patient's actions mutually affect each other. By way of example, a clinician interacts with a patient any time the clinician is actively monitoring or overseeing administration of a medical treatment for the patient. A recent interaction may be generally defined according to default rules or parameters set by a user of the situational awareness system 206 (e.g., a recent interaction may include any interaction that occurred within the past five minutes). It will be understood that inputs other than those described above (e.g., patient information and clinician information) may be used to determine that a clinician and patient are in the same location, are currently interacting with each other, or have recently interacted with each other. Such inputs are within the scope of the embodiments described herein.

Upon determining that a patient and at least one clinician are in the same location, are interacting with each other, or have recently interacted with each other, the determining component 224 secondly determines that the clinician is accessing either incorrect or correct health information for the patient. The determination may be based on, in one aspect, the content of an open patient EMR application that was opened by a clinician. If the open portion of the EMR contains patient-identifying information for the already-located and identified patient (or the patient that recently interacted with or is currently interacting with the clinician), the health information being accessed or documented may be determined to be correct for the patient. If the patient-identifying information is associated with a patient other than the located and identified patient (or the patient that recently interacted with or is currently interacting with the clinician), the health information being accessed or documented may be determined to be incorrect for the patient. Likewise, if the patient-identifying information is associated with more than one patient, the health information being accessed or documented may also be determined to be incorrect for the patient. For example, clinician information may indicate that a clinician is scheduled to perform surgery on patient Y from 9:00 AM to 11:00 AM in room 400. The determining component 224 is configured to determine that correct health information accessed on computing devices in room 400 between 9:00 AM and 11:00 AM will include identifying information for patient Y.

In a second embodiment, the determining component 224 is configured to determine that a clinician is accessing and/or documenting correct or incorrect health information for a particular patient encounter. The determining component 224 makes such a determination based, at least in part, on first determining that an interaction is occurring between a patient and a clinician. The determining component 224 makes such a determination utilizing patient and clinician information, as described above.

The determining component 224 next determines that the interaction between the patient and the at least one clinician can be described by an ongoing patient encounter. Such a determination is made by utilizing logic-based rules and the patient and the clinician information received at the receiving component 222. For example, patient information for patient A may indicate that patient A has one active encounter (e.g., an encounter related to a hospital stay for pneumonia) in her EMR. Clinician information may indicate that clinician Y is assigned to patient A's treatment for pneumonia (the patient encounter). Other patient and clinician information may also indicate that patient A and clinician Y are currently in the same location. Based on such inputs, the determining component 224 may determine that the interaction between patient A and clinician Y describes an ongoing patient encounter (e.g., patient A's hospital stay for pneumonia).

Upon determining that a current or recent interaction between a patient and at least one clinician describes an ongoing patient encounter, the determining component 224 can then determine that the at least one clinician is accessing incorrect or correct health information for the patient encounter. The determination may be based on, in one aspect, the content of a patient EMR application that the clinician has open on the end-user computing device 208. If the open portion of the EMR contains health information with a patient encounter code for the ongoing patient encounter, the health information may be determined to be correct for the patient encounter. If the health information contains a different patient encounter code than the code associated with the ongoing patient encounter, or it contains more than one patient encounter code, the health information may be determined to be incorrect for the patient encounter.

By way of example, the determining component 224 may determine that an ongoing patient encounter is occurring in operating room 100 on Feb. 15, 2013 at 10:00 AM. If, in operating room 100 at 10:08 AM on Feb. 15, 2013, two computing devices have open EMR applications that contain patient encounter codes of 76580, and two other computing devices have open EMR applications that contain patient encounter codes of 77665, the determining component 224 is configured to determine that incorrect health information is being accessed (i.e., because more than one open EMR applications contain different patient encounter codes). The determining component 224 is also configured to determine that the health information containing patient encounter code 77665 is correct health information because it relates to patient, Bob Allen, who, based on patient information associated with a patient location, is determined to be located in operating room 100 at 10:00 AM on Feb. 15, 2013.

While each of these steps, i.e., determining that health information is correct for a patient and determining that health information is correct for a patient encounter, are described as distinct events, it will be understood that these determinations may occur simultaneously or near simultaneously and/or in any order. Additionally, making such determinations may depend on identical or overlapping information (e.g., patient and clinician information relating to a scheduled medical treatment).

In a third embodiment, the determining component 224 is configured to determine that correct health information includes information relating to an ongoing patient encounter. The determining component 224 makes such a determination by utilizing patient and clinician information that indicates that a clinician is assigned to care for a patient during a particular ongoing patient encounter. For example, clinician and patient information may indicate that both the clinician and patient are scheduled to be in the same operating at the same time. If, during the ongoing patient encounter, the clinician assigned to the patient accesses health information relating to the patient, but not relating to an ongoing patient encounter (i.e., a completed/not yet started patient encounter), the health information may be determined to be incorrect.

It will be understood that each and every one of these embodiments is contemplated as being within the scope of the invention, as described herein. Additionally, each of these embodiments may best be illustrated by the following examples used for illustrative purposes only:

### Example 1

Patient information indicates that patient, Bob Allen, is scheduled to begin surgery at 8 AM on Feb. 12, 2013 in operating room A2. The determining component 224 may determine that health information being accessed in room A2 at 8:05 AM on Feb. 12, 2013 that does not contain patient-identifying information for Bob Allen is incorrect.

### Example 2

Continuing with example 1, assume that patient information indicates that Bob Allen was admitted to the hospital at 7:30 AM on Feb. 12, 2013. Assume also that patient information indicates that Bob Allen was assigned a patient encounter code (e.g., a billing code) of 12345 upon admission. Further, assume clincian information indicates that Bob Allen's surgeon, Dr. Jones, is in Bob Allen's recovery room at 11:00 AM on Feb. 12, 2013. As soon as Dr. Jones leaves Bob Allen's room and logs in to Bob Allen's patient EMR, the determining component 224 may determine that health information containing the patient encounter code “12345” is correct health information for the patient encounter (i.e., because the recent interaction between Dr. Jones and Bob Allen indicates that health information containing patient encounter code 12345 is relevant to Dr. Jones).

### Example 3

Patient information for Patient A may identify two patient encounters for Patient A: the first patient encounter may be “active” (i.e., noted in patient A's EMR as being “in progress”), and the second patient encounter may be scheduled to begin in the future. The determining component 224 may determine that correct health information relates to the active patient encounter, rather than the patient encounter scheduled for a future date (i.e., a patient encounter that is ongoing is more likely to be relevant to an interaction between a clinician and a patient).

### Example 4

Based on the same facts as Example 3, assume patient information for Patient A also indicates that Patient A has a third patient encounter for which discharge instructions were given, indicating that the third patient encounter is complete. The determining component 224 may determine that correct health information still relates to the active patient encounter and not the patient encounter for which discharge orders were given (i.e., a patient encounter that is ongoing is more likely to be relevant to an interaction between a clinician and a patient).

### Example 5

Clinician and patient information may indicate that Clinicians A, B, and C are scheduled to perform patient Bob Allen's knee surgery, assigned a patient encounter code of 55599AZS, at 8:00 AM, on Feb. 12, 2013, in operating room (OR) 505. At 8:05 AM, on Feb. 12, 2013, clinician and patient information may indicate that Clinicians A, B, and C, and patient, Bob Allen, are located in OR 505. Using rules and logic, the determining component 224 may determine that health information being accessed by Clinicians A, B, and C on computing devices located in OR 505 is correct, if it contains patient-identifying information for Bob Allen (e.g., Bob Allen's name and social security number) and the patient encounter code for Bob Allen's knee surgery and subsequent recovery stay in the hospital (e.g., 55599AZS).

### Example 6

Patient information indicates that an operation is scheduled from 8:30 AM to 10:30 AM in operating room 100, on Feb. 12, 2013, for patient Sally Walsh, who has a social security number of 145872325. The determining component 224 is configured to determine that health information being accessed in operating room 100 at 9:30 AM, on Feb. 12, 2013, and containing Hal Barker's name and a social security number of 354876453 (i.e., different patient-identifying information from Sally Walsh) is incorrect.

### Example 7

Clinician information indicates that Clinicians A and B are currently performing knee surgery on patient Joe Smith. Patient information indicates that the knee surgery has a patient encounter code of 56999 and is in progress. While in the operating room, clinician information may also indicate that Clinician A has logged in to the EMR system on a computing device in the operating room. If the health information accessed by Clinician A contains a unique patient encounter code of 56734, the determining component 224 is configured to determine that the health information relates to an incorrect patient encounter because it contains a patient encounter code (i.e., 56734) that does not match the patient encounter code for the knee surgery (i.e., 56999).

The accessing component 226 is configured to automatically access correct health information and present it to one or more clinicians. Upon determining that a patient and at least one clinician are interacting with one another and/or are located at a same location during an ongoing patient encounter, the accessing component 226 can identify the patient (i.e., based on received patient information). The accessing component 226 can thereafter mine the patient's EMR for information relating to the patient (i.e., information containing patient-identifying information associated with the patient) and/or the correct patient encounter (i.e., information containing the patient encounter code associated with the ongoing patient encounter).

Additionally, the accessing component 226 is configured to automatically access correct health information or provide a link to correct health information before an ongoing patient encounter is scheduled to begin. For example, the receiving component 222 may receive patient information indicating that a patient's surgery is assigned a patient encounter code of 555338 and will begin at 9:00 AM on Feb. 14, 2013 in room 800. The receiving component 222 may also receive information that the patient is in room 800 at 8:50 AM, based on, for example, patient information associated with a patient's location. As well, the receiving component 222 may receive clinician information indicating that one or more clinicians are logged in to computing devices in room 800 at 8:50 AM. Based on such information, the accessing component 226 may access health information with a patient encounter code of 555338 and present the information on each of the respective computing devices located in room 800 on or around 9:00 AM.

The notifying component 228 sends a notification to at least one clinician when the clinician is accessing and/or documenting incorrect health information, as determined by the determining component 224. The notification can be displayed on any system capable of communicating via the network 204, including the end-user computing device 208. The notification is not meant to be limited to merely visual displays. The notification can include sounds, lights, textual instructions/commands, and the like. For instance, if at least one clinician is accessing incorrect health information for a patient on the end-user computing device 208, a red flashing dialog box may appear on the display monitor 209 of the end-user computing device 208. The dialog box may include textual information indicating that a clinician is accessing and/or documenting incorrect health information and/or describe steps the clinician may take to rectify the error. As well, an option to select to override or ignore the notification may be given to the clinician. The notification also can be sent to a plurality of participating clinicians, and not only the clinician accessing the incorrect health information. In one embodiment, the notification can be sent to a non-participating clinician or other healthcare facility employees (e.g., the head OR nurse or scheduler). Further, the notification can merely indicate that incorrect or incongruent health information is being accessed without providing any further instruction to a clinician.

In another aspect, the notifying component 228 may prevent or block one or more clinicians from further accessing or documenting incorrect health information. For example, if a clinician is accessing incorrect health information, the clinician may be prevented from entering clinician notes in the incorrect portion of the EMR. Once blocked, a clinician may be presented with an option to log out and log back in to the EMR system, close the application containing the incorrect patient information, or select to override the block and continue to view the information the clinician was previously viewing.

In other aspects, the notification can include a list of actions that one or more clinicians/users can take, including, for instance, selecting to view at least one item of health information that may be accessed by the accessing component 226. The notification can also include an indication communicated to at least one clinician that the clinician should deselect at least one item of information from the incorrect portion of the EMR (i.e., information containing patient-identifying information for the wrong patient or a patient encounter code for the incorrect patient encounter) and select at least one item of information from a correct portion of an EMR (i.e., information containing patient-identifying information for a correct patient or a patient encounter code for a correct patient encounter). Selecting and deselecting information might include opening or closing one or more applications on the end-user computing device 208.

The notifying component 228 is also configured to generate reminders for clinicians, indicating that a clinician needs to document health information related to a particular patient and/or patient encounter. Such reminders may be based on a determination by the determining component 224 that a clinician has recently interacted with a patient and a predefined period of time (as defined by a user) has passed since the interaction. Reminder notifications may be communicated directly to a clinician, such as on a computing device, a phone, a pager or any other suitable electronic communication device associated with the clinician.

FIG. 3 depicts a flow diagram of an exemplary method 300 for determining that correct or incorrect health information is being accessed. At a step 310, one or more inputs that indicate the location of a first patient are received by a receiving component, such as the receiving component 222 of FIG. 2. These inputs may be received from one or more healthcare systems (e.g., real-time location), EMRs or data stores, such as the healthcare systems 210 or the data store 202 of FIG. 2. At a step 312, inputs are received that indicate that a clinician is located at a location associated with the patient. Such inputs may indicate that the clinician is in the same room as the first patient, surrounding the first patient, or within a predefined distance to the patient. Additional information, such as whether the clinician is assigned to or associated with the patient, may also be received.

At a step 314, information is received that the clinician that is located at the location associated with the patient is accessing and/or documenting health information related to at least a second patient. As part of this step, information that indicates that a clinician is logged in to a patient EMR is first received. A clinician is logged in to a patient EMR, if his/her login credentials have been authenticated. Next, information is received describing the type and location of a computing device the clinician used to log in to the patient EMR, as well as an identity of the clinician (e.g., name, social security number, specialty, or the like). Once a computing device is identified, the content of health information being accessed on the computing device is also received. The health information being accessed relates to a second patient, if it includes patient-identifying information for a second patient (i.e., a different patient than the first patient).

At a step 316, a notification that indicates that the clinician is accessing information for the second patient is communicated by a notifying component, such as the notifying component 228 of FIG. 2, to the computing device being used by the clinician. The notification may be in the form of a visual display. The notification also can include sounds, lights, textual instructions/commands, and the like. For instance, when the clinician accesses information related to the second patient, a red flashing dialog box containing textual phrases may appear on the monitor to alert the clinician that she should close or deselect the health information for the second patient. The notification also may be sent to other clinicians participating in the patient encounter and/or non-participating clinicians (e.g., a head charge nurse).

In one embodiment, the notification can indicate merely that incorrect or incongruent health information is being accessed. In other embodiments, the notification can include a list of actions that one or more clinicians can take, including, for instance, selecting health information for the first patient. The notification can also include an indication that at least one clinician should deselect a portion of the EMR that relates to the second patient and, instead, select at least a portion of the first patient's EMR. The health information that relates to the second patient can be deselected by closing the portion of the EMR that contains the second patient's health information. Health information relating to the first patient may be selected by opening a portion of the first patient's EMR.

While not depicted in FIG. 3, the notification can also include a link to the first patient's health information. A link to the first patient's information may be created by an accessing component, such as the accessing component 226 of FIG. 2. The accessing component accesses the first patient's health information by mining an EMR system for patient-identifying information related to the first patient. The identity of the first patient, as described above, is determined by a determining component, such as the determining component 224 of FIG. 2, based on patient and clinician received at the receiving component. The accessing component then communicates the link to a clinician on the computing device.

FIG. 4 depicts a flow diagram of an exemplary method 400 for determining that one or more clinicians are accessing incorrect health information for a particular patient encounter. At a step 410, the location of a patient during a first patient encounter is received by a receiving component, such as receiving component 222 of FIG. 2, based on input from healthcare systems or a data store, such as the healthcare systems 210 or the data store 202 described in FIG. 2. At a step 412, the location of one or more clinicians participating in the first patient encounter is also received. Information related to the location of a patient or clinician may be received from a real-time location system, for example.

At a step 414, an indication is received that the one or more clinicians are accessing at least a portion of an EMR related to the first patient during the first patient encounter. The portion of the EMR that is related to the first patient contains patient-identifying information associated with the first patient. At a step 416, a determining component, such as the determining component 224 of FIG. 2, determines whether the clinician is accessing health information that relates to the first patient encounter. At a step 418, if the health information contains a patient encounter code associated with the first patient encounter, no further action is taken. At a step 420, if the health information contains a patient encounter code that is different than the patient encounter code associated with the first patient encounter, or if it contains multiple patient encounter codes, a notification is communicated to the clinician by a notifying component, such as notifying component 228 of FIG. 2. The notification may indicate either that the health information fails to correspond to the first patient encounter and/or that the health information is incorrect.

Although not shown, the notification can also include an option for the clinician to select a portion of an EMR that contains correct health information (i.e., information relating to the first patient encounter). The notification may also include an option to deselect the portion of the EMR that fails to correspond to the first patient encounter. Upon communicating the notification to the clinician, an indication may be received that a portion of the EMR that fails to correspond to the first patient encounter has been deselected and/or a portion of an EMR that corresponds to the first patient encounter has been selected. When the portion of the EMR that corresponds to the first patient encounter has been selected, no further action will be taken. As well, information associated with the first patient encounter (i.e., containing a patient encounter code associated with the first patient encounter) may be automatically accessed by an accessing component, such as the accessing component 226 of FIG. 2, and communicated to a clinician by the notifying component.

Turning to FIG. 5, a method 500 depicts a flow diagram of an exemplary method 500 for determining that one or more clinicians are accessing correct health information for a particular patient encounter. At a step 510, an indication of an ongoing first patient encounter associated with a first patient is received by a receiving component, such as receiving component 222 of FIG. 2. The indication may include patient and/or clinician-related information that suggests that a medical treatment, an interaction between a clinician and a patient, or a patient's visit to a healthcare facility has begun but not ended (e.g., information relating to a patient being scheduled for inpatient care for five days). As well, the information may include a patient encounter code associated with the ongoing patient encounter. The information may be received from a plurality of healthcare systems or patient EMRs, such as the healthcare systems 210 of FIG. 2.

At a step 512, an indication that a clinician is assigned to care for the patient is received at the receiving component. For example, patient information from a patient EMR that lists “Dr. Mark Gregory” as a patient's primary care physician indicates that Dr. Mark Gregory is assigned to care for the patient. At a step 514, an indication that the clinician is accessing at least a portion of an EMR associated with the first patient is also received. The indication may first include information that a clinician has logged in to a patient EMR. The indication may next include an indication of the content within the open patient EMR. The content of the EMR is associated with the first patient, if it contains patient-identifying information for the first patient (e.g., the first patient's name, date of birth, social security number, or the like).

At a step 516, it is determined by a determining component, such as determining component 224 of FIG. 2, that the portion of the open EMR that is being accessed by the clinician relates to at least a second patient encounter (i.e., a patient encounter different than the first patient encounter). The determination is made at least because the portion of the EMR that is open does not contain the patient encounter code associated with the first patient encounter. Finally, at a step 518, a notification is communicated to the clinician indicating that the health information being accessed relates to the second patient encounter. The notification may be displayed on the computing device the clinician is logged in to, or it may be communicated to the clinician on a separate communication device also associated with the clinician (e.g., the clinician's mobile phone).

In conclusion, methods and systems for determining that a clinician is accessing correct or incorrect health information for a patient or a patient encounter are provided. Based on inputs received from a plurality of healthcare systems, the system described herein is capable of determining and notifying a clinician when health information being accessed is likely incorrect. The determination that incorrect health information is being accessed is made because either the health information fails to include patient-identifying information for a particular patient, or it fails to include a patient encounter code associated with a particular ongoing patient encounter.

The present invention has been described in relation to particular embodiments, which are intended in all respects to be illustrative rather than restrictive. Alternative embodiments will become apparent to those of ordinary skill in the art to which the present invention pertains without departing from its scope.

The invention claimed is:

1. One or more computer storage media having computer-executable instructions embodied thereon that, when executed, perform a method of determining that correct health information is being accessed for a patient, the method comprising:
receiving one or more inputs indicating a location associated with a first patient;
receiving one or more inputs indicating that one or more clinicians are at the location associated with the first patient;
receiving an indication that at least one clinician of the one or more clinicians is accessing an electronic medical record (EMR) associated with a second patient; and
communicating a notification to the at least the one clinician, wherein the notification comprises an indication that the at least one clinician is accessing the EMR associated with the second patient.

2. The media of claim 1, wherein at least one input of the one or more inputs is received from a real-time location system.

3. The media of claim 1, wherein at least one input of the one or more inputs is received from a scheduling system.

4. The media of claim 1, wherein the one or more clinicians are at a location associated with the first patient when they are located in a same room as the first patient.

5. The media of claim 1, wherein the one or more clinicians are at the location associated with the first patient when they are within a predefined distance to the first patient.

6. One or more computer storage media having computer-executable instructions embodied thereon that, when executed, perform a method of determining that correct health information is being accessed during a patient encounter, the method comprising:
receiving one or more inputs indicating a location associated with a first patient during a first patient encounter;
receiving one or more inputs indicating that one or more clinicians are at the location associated with the first patient;
receiving an indication that at least one clinician of the one or more clinicians is accessing at least a portion of an electronic medical record (EMR) associated with the first patient; and
determining whether the at least the portion of the EMR accessed by the at least one clinician corresponds to the first patient encounter, wherein:
(A) if the at least the portion of the EMR corresponds to the first patient encounter, not taking any further action, and wherein
(B) if the at least the portion of the EMR fails to correspond to the first patient encounter, communicating a notification to the at least one clinician.

7. The media of claim 6, wherein the first patient encounter is associated with one or more medical treatments.

8. The media of claim 6, wherein the first patient encounter comprises a visit to a healthcare facility.

9. The media of claim 6, wherein the first patient encounter is associated with a unique patient encounter code.

10. The media of claim 9, wherein the at least the portion of the EMR corresponds to the first patient encounter when it contains the unique patient encounter code associated with the first patient encounter.

11. The media of claim 6, further comprising:
identifying at least one portion of the EMR that corresponds to the first patient encounter;
automatically accessing the at least one portion of the EMR that corresponds to the first patient encounter; and
communicating a link to the at least one portion of the EMR to the at least one clinician.

12. The media of claim 6, wherein the notification further comprises an option to select at least one portion of an EMR that corresponds to the first patient encounter.

13. The media of claim 6, wherein the notification further comprises an option to deselect the at least the portion of the EMR that fails to correspond to the first patient encounter.

14. The media of claim 6, further comprising:
upon communicating the notification to the at least one clinician, receiving an indication that the at least the portion of the EMR that fails to correspond to the first patient encounter has been deselected; and
upon communicating the notification to the at least one clinician, receiving an indication that at least one portion of an EMR that corresponds to the first patient encounter has been selected.

15. The media of claim 6, further comprising preventing the at least one clinician from accessing the at least the portion of the EMR that fails to correspond to the first patient encounter.

16. The media of claim 6, wherein receiving the indication that at least one clinician of the one or more clinicians is accessing at least a portion of an EMR associated with the first patient further comprises receiving an indication that one or more applications are open on a computing device associated with the at least one clinician.

17. One or more computer storage media having computer-executable instructions embodied thereon that, when executed by one or more computing devices, perform a method of determining that correct health information is being accessed during a patient encounter, the method comprising:
receiving an indication of an ongoing first patient encounter associated with a first patient;
receiving an indication that one or more clinicians are assigned to care for the first patient;
receiving an indication that at least one clinician of the one or more clinicians is accessing at least a portion of an electronic medical record (EMR) associated with the first patient;
determining that the at least the portion of the EMR corresponds to a second patient encounter; and
communicating to the at least one clinician a notification that the at least the portion of the EMR corresponds to the second patient encounter.

18. The media of claim 17, wherein the indication that one or more clinicians are assigned to care for the first patient is based at least in part on information received from a plurality of healthcare information systems.

19. The media of claim 17, wherein the determining that the at least the portion of the EMR corresponds to the second patient encounter further comprises determining that the ongoing first patient encounter and the second patient encounter are associated with different patient encounter codes.

20. The media of claim 19, wherein the different patient encounter codes comprise different billing codes.
